(19) United States
(12) Patent Application Publication
(10) Pub. No.: US 2022/0171374 A1
(43) Pub. Date: Jun. 2, 2022

(54) DEFECT PROFILING AND TRACKING SYSTEM FOR PROCESS-MANUFACTURING ENTERPRISE

(71) Applicant: Noodle Analytics, Inc., San Francisco, CA (US)

(72) Inventors: Gopal Datt Joshi, Bengaluru (IN); Amar Kumar, Bihar (IN); Naveen Tewari, Bengaluru (IN)

(21) Appl. No.: 17/165,938

(22) Filed: Feb. 3, 2021

(30) Foreign Application Priority Data
Dec. 2, 2020 (IN) 202041052416

(51) Int. Cl. G05B 19/418; G05B 13/02

(52) U.S. Cl. CPC G05B 19/41875; G05B 13/0295; G05B 19/4183; G05B 19/4188

(57) ABSTRACT

A defect profiling and tracking system for a process-manufacturing enterprise is provided. The system includes a memory and a processor. The processor is configured to access entity data for a plurality of entities of the process-manufacturing enterprise and process parameter data for one or more deviating entities. The processor is configured to analyze the entity data and the process parameter data for each of the deviating entities to determine a plurality of relationships between quality defects and the process parameters to generate a unique entity specific process signature (EPS) for each entity. The processor is configured to receive real-time process parameter data for one or more entities to generate a real-time process signature for the one or more entities and compare the real-time process signature of each entity with EPS corresponding to the entity to detect one or more EPS matches that are indicative of a quality defect.

### PRIORITY STATEMENT

The present application claims priority under 35 U.S.C. §119 to Indian patent application number 202041052416 filed on Dec. 2, 2020, the entire contents of which are hereby incorporated herein by reference.

### FIELD

The invention relates generally to defect monitoring in process-manufacturing enterprises, and more particularly to, techniques for defect profiling in such environments.

### BACKGROUND

Process manufacturing enterprises transform raw materials into completely new finished products. Such enterprises have applications in food, beverage, chemical, metals and pharmaceutical industries, among others. Typically, process-manufacturing enterprises employ process control mechanism to closely monitor and control the various operations of the enterprises.

Process control systems are typically employed to monitor and control operating parameters of various operations of process-manufacturing enterprises. Such systems facilitate automation of the processes to reduce human intervention and ensure maximum efficiency without additional expenditures. A variety of sensors and data acquisition systems are employed to acquire real-time data about the processes and sensors continuously measure the state of the respective processes and operations in a pre-defined configured time interval.

As an example, in a structural steel manufacturing unit, process control systems are employed to ensure proper temperature of blast furnaces, control the viscosity of molten metal, and for other such tasks that help meeting the product specifications. Unfortunately, despite the advances in the current process control mechanisms, number and types of defects occurring in process-manufacturing enterprises are still substantially high due to factors such as interactions between controllable and uncontrollable parameters, upstream and downstream processes and so forth. Moreover, the current process control systems are not customizable to various defect types.

Moreover, existing techniques such as univariate control charts used in Process Monitoring and Quality Assurance (PMQA) systems are interpretable but they are not able to encode complex interactions of the process parameters in process-manufacturing enterprises. Further, other techniques like multi-variate control charts or higher order charts can encode the complex interactions of the process parameters. However, they are not easily interpretable by the human operators. As a result, human operators have to use their domain expertise to narrow down identified unusual process operation state to one of the known defect categories.

In addition, most of the current process control systems are designed to be used as a single system throughout the enterprise and do not take into account the fact that behaviour across different parts of the enterprise or across similar enterprises can be different. In addition, the underlying defect tracking, monitoring and controlling models/algorithms cannot be customized making them inefficient and not usable by certain customers.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a defect profiling and tracking system for a process-manufacturing enterprise is provided. The system includes a memory having computer-readable instructions stored therein and a processor configured to execute the computer-readable instructions to access entity data for a plurality of entities of the process-manufacturing enterprise. The entity data includes at least one of product specifications, a defect type, defect specifications and location information. The processor is configured to access process parameter data for one or more deviating entities. The process parameter data includes at least one of process readings, setup points and defect labels for the respective entities. The processor is configured to analyze the entity data and the process parameter data for each of the deviating entities to determine a plurality of relationships and/or interactions between quality defects and the process parameters and to generate a unique entity specific process signature (EPS) for each entity. The processor is configured to receive real-time process parameter data for one or more entities to generate a real-time process signature for each of the one or more entities and compare the real-time process signature of each entity with EPS corresponding to the entity to detect one or more EPS matches. The EPS matches are indicative of a quality defect and/or a process deviation.

According to another example embodiment, a defect profiling and tracking system for a process-manufacturing enterprise is provided. The system includes a memory having computer-readable instructions stored therein and a processor configured to execute the computer-readable instructions to access product quality defect data and process parameter data for a plurality of entities of the process-manufacturing enterprise and to encode relationships between the product quality defect data and process parameter data for one or more entities. The processor includes an entity characterization module configured to analyze product quality defect data for the plurality of entities to identify one or more deviating entities and an entity specific process signature (EPS) generator configured to analyze the product quality defect data and the process parameter data for the identified deviating entities to determine a plurality of relationships and/or interactions between quality defects and the process parameters and to generate a unique entity specific process signature (EPS) for each entity. The processor also includes an EPS fuzzy matcher module configured to compare a plurality of real-time process signatures of each entity with EPS corresponding to the entity to detect one or more EPS matches. The EPS matches are indicative of a quality defect and/or a process deviation.

According to another example embodiment, a computer-implemented method for defect profiling and tracking for a process-manufacturing enterprise is provided. The method includes accessing entity data for a plurality of entities of the process-manufacturing enterprise. The entity data includes at least one of product specifications, a defect type, defect specifications and location information. The method also includes accessing process parameter data for one or more deviating entities. The process parameter data includes at least one of process readings, setup points and defect labels for the respective entities. The method includes analyzing the entity data and the process parameter data for each of the deviating entities to determine a plurality of relationships and/or interactions between quality defects and the process parameters and to generate a unique entity specific process signature (EPS) for each entity. The method also includes receiving real-time process parameter data for one or more entities to generate a real-time process signature for each of the one or more entities and comparing the real-time process signature of each entity with EPS corresponding to the entity to detect one or more EPS matches. The EPS matches are indicative of a quality defect and/or a process deviation.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 illustrates a defect profiling and tracking system for a process-manufacturing enterprise in accordance with embodiments of the present technique;

FIG. 2 is an example embodiment of a process-manufacturing enterprise with the defect profiling and tracking system of FIG. 1, according to the aspects of the present technique;

FIG. 3 is a block diagram for illustrating a computer-implemented process for defect profiling and tracking using the system of FIG. 1, according to the aspects of the present technique;

FIG. 4 illustrates an example difference map generated (EPS signature) by the system of FIG. 1 for a normal product, according to the aspects of the present technique;

FIG. 5 illustrates a difference map of a defective product generated (EPS signature) by the system of FIG. 1., according to the aspects of the present technique; and

FIG. 6 is a block diagram of an embodiment of a computing device in which the modules of the defect profiling and tracking system, described herein, are implemented.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in ‘addition to the orientation depicted in the figures. For example, if the device in the figures is turned over, elements described as “below” or “beneath” other elements or features would then be oriented “above” the other elements or features. Thus, term such as “below” may encompass both an orientation of above and below. The device may be otherwise oriented (rotated 90 degrees or at other orientations) and the spatially relative descriptors used herein are interpreted accordingly.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The device(s)/apparatus(es), described herein, may be realized by hardware elements, software elements and/or combinations thereof. For example, the devices and components illustrated in the example embodiments of inventive concepts may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or more software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described example embodiments of the inventive concept may be implemented with program instructions which may be executed by computer or processor and may be recorded in computer-readable media. The media may also include, alone or in combination with the program instructions, data files, data structures, and the like. The program instructions recorded in the media may be designed and configured especially for the example embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to execute one or more software modules to perform the operations of the above-described example embodiments of the inventive concept, or vice versa.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Example embodiments are generally directed to defect monitoring and control in process manufacturing enterprises and, more particularly to, defect profiling and tracking in such enterprises. In particular, the techniques described here facilitate defect monitoring by generating encoded defect-specific process signature for entities of the respective enterprise.

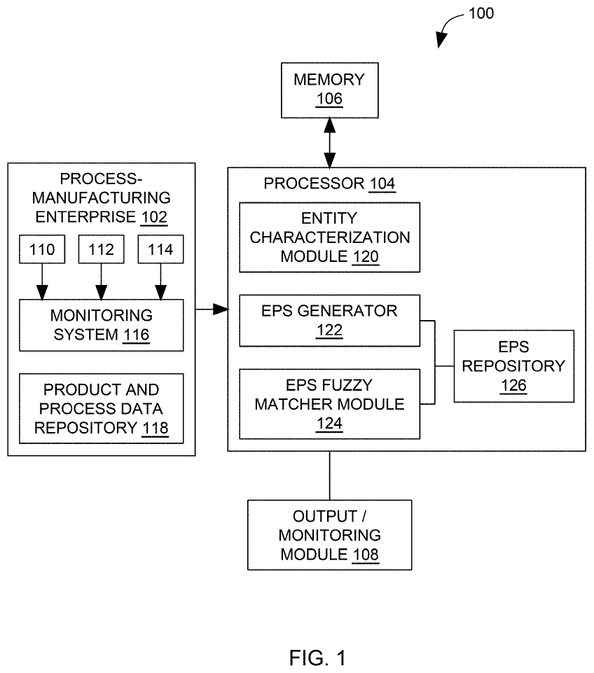

FIG. 1 illustrates a defect profiling and tracking system 100 for a process-manufacturing enterprise 102 in accordance with embodiments of the present technique. The defect profiling and tracking system 100 includes a processor 104, a memory 106 and an output/monitoring module 108. Each component of the system 100 is described in further detail below.

The process-manufacturing enterprise 102 includes a plurality of entities such as generally represented by reference numerals 110, 112 and 114 that facilitate operation of the process-manufacturing enterprise 102. In some embodiments, the process-manufacturing enterprise 102 may include a manufacturing plant, a mill, an industrial set up, an assembly line, or combinations thereof. In the illustrated embodiment, a process monitoring and control system 116 monitors and adjusts/controls process parameters and/or operational state of each of the plurality of entities 110, 112 and 114 to facilitate smooth operation of the process-manufacturing enterprise 102. In one example, such product and process related data for the entities 110, 112 and 114 may be stored in a product and process data repository 118.

In operation, the processor 104 is configured to execute computer-readable instructions to access data such as product quality defect data and process parameter data for the plurality of entities 110, 112 and 114 of the process-manufacturing enterprise 102. Such data may be accessed from the product and process data repository 118. Examples of the product quality defect data includes, but is not limited to, product specifications, a defect type, defect specifications and location information for the entities 110, 112 and 114. Moreover, examples of process parameter data includes, but is not limited to, process readings, setup points and defect labels for the respective entities 110, 112 and 114. The processor 104 is configured to encode relationships between the product quality defect data and process parameter data for the one or more entities 110, 112 and 114.

In this embodiment, the processor 104 includes an entity characterization module 120, an entity specific process signature (EPS) generator 122 and an EPS fuzzy matcher module 124. The entity characterization module 120 is configured to analyze the product quality defect data for the plurality of entities 110, 112 and 114 and to identify one or more deviating entities from the plurality of entities 110, 112 and 114. Moreover, the EPS generator 122 is configured to analyze the product quality defect data and the process parameter data for the identified deviating entities to determine a plurality of relationships and/or interactions between quality defects and the process parameters and to generate a unique entity specific process signature (EPS) for each entity such as 110, 112 and 114.

Further, the EPS fuzzy matcher module 124 is configured to compare a plurality of real-time process signatures of each entity with EPS corresponding to the entity to detect one or more EPS matches. It should be noted that the EPS matches are indicative of a quality defect and/or a process deviation. In certain embodiments, the processor 104 further includes an EPS repository 126 communicatively coupled to the EPS generator 122 and to the EPS fuzzy matcher module 124. The EPS repository 126 is configured to store the EPS for each of the deviating entities and data in the EPS repository 126 is updated with the EPS matches on a periodic basis. The EPS matches for the deviating entities may be communicated to a user/operator via the output/monitoring module 108. The system 100 can be integrated with existing quality monitoring and control systems of the enterprises such as referenced by number 102 to facilitate defect monitoring and tracking. The system 100 is configured to provide traceability of quality defects and provides opportunity for the reverse optimization process to human operators. Further, the system 100 is capable of handling multiple defect types and multi-stage manufacturing setup in a unified framework. The techniques described above can be extended to detection of defect signatures for various mill operation areas of the production. In such embodiments, location details may be integrated with the product specification and defect details using for each entity.

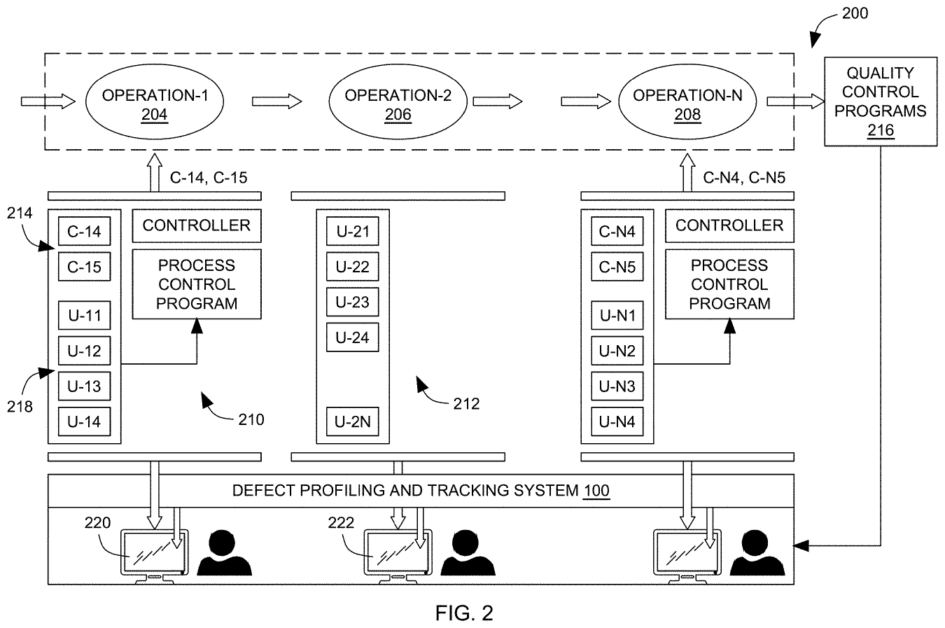

FIG. 2 is an example embodiment of a process-manufacturing enterprise 200 with the defect profiling and tracking system 100. As can be seen, the enterprise 200 may include a number of ongoing operations such as represented by reference numerals 204, 206 and 208 for entities such as 110, 112 and 114 of the enterprise 200. In the illustrated embodiment, the process operating parameters for these operations 204, 206 and 208 may be monitored in accordance with the processing instructions for each of the operations 204, 206 and 208. The enterprise 200 may include a plurality of sensors and data acquisition systems such as represented by reference numerals 210 and 212 to gather real-time data about the operations 204, 206 and 208. In operation, the sensors such as 210 and 212 measure the state of the respective processes/operations over a pre-defined configured time interval. It should be noted that process parameters such as represented by reference numeral 214 are controlled by a control program/system 216 and are generally referred herein as controlled process parameters. Moreover, certain process parameters 218 are referred herein as uncontrolled process parameters that are not controlled by such programs.

As an example, a structural steel manufacturing unit may employ process controls for tasks such as ensuring the proper temperature of blast furnaces, controlling the viscosity of molten metal, among others. The control program 216 may receive inputs such as temperature feed from the sensor measurements and makes required adjustments through a controller (not shown) if the temperature deviates from a specified value. It should be noted that though a steel manufacturing unit is considered as an example here, the technique may be utilised in a variety of process-manufacturing units. Examples of such units include, but are not limited to, manufacturing plant, a mill, an industrial set up, an assembly line, or combinations thereof. In one embodiment, the product quality status may be communicated to one or more users/operators via output/monitoring modules such as represented by reference numerals 220 and 222 of the enterprise 200. The defect profiling and tracking system 100 is configured to be integrated with an existing process control program (PCP), process monitoring and quality assurance (PMQA) program, quality control program, or combinations thereof of the process-manufacturing enterprise 102.

In the illustrated embodiment, the defect profiling and tracking system 100 is configured to access the process parameter data such as the controlled and uncontrolled process parameters 214 and 218 and uses such data to detect defective entities and communicates information corresponding to such entities to the one or more users/operators via output modules 220 and 222 of the enterprise 200. In particular, the defect profiling and tracking system 100 is configured to access entity data for the entities of the process-manufacturing enterprise 200. The entity data comprises at least one of product specifications, a defect type, defect specifications and location information.

Further, the system is configured to access process parameter data for one or more deviating entities. The process parameter data includes at least one of process readings, setup points and defect labels for the respective entities such as received via sensors and data acquisition systems such as represented by reference numerals 210 and 212. The system 100 is configured to analyze the entity data and the process parameter data for each of the deviating entities to determine a plurality of relationships and/or interactions between quality defects and the process parameters and to generate a unique entity specific process signature (EPS) for each entity. The system 100 is further configured to receive real-time process parameter data for one or more entities to generate a real-time process signature for each of the one or more entities and to compare the real-time process signature of each entity with EPS corresponding to the entity to detect one or more EPS matches, wherein the EPS matches are indicative of a quality defect and/or a process deviation.

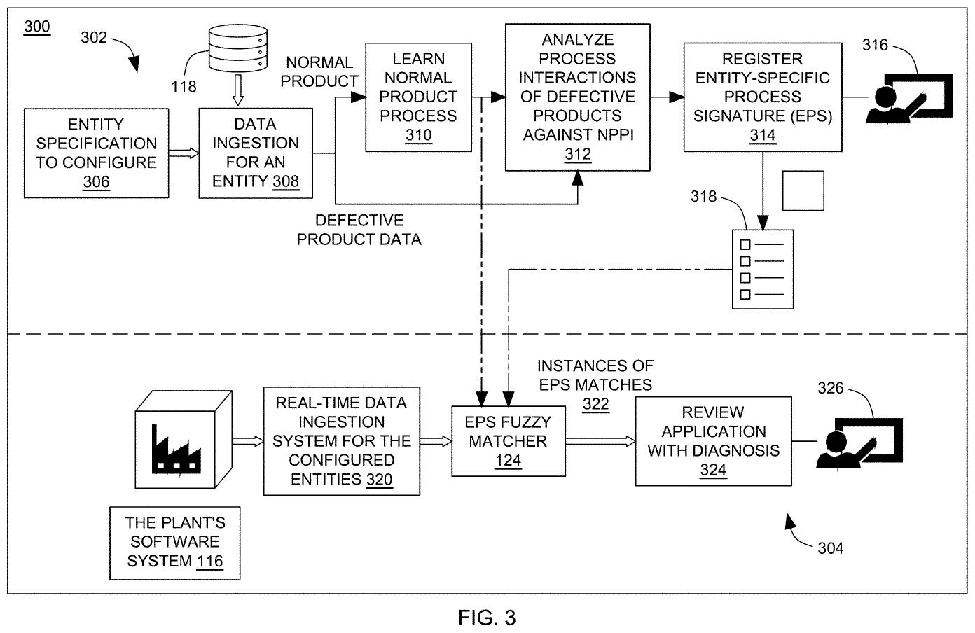

FIG. 3 is a block diagram for illustrating a computer-implemented process 300 for defect profiling and tracking using the system 100 of FIG. 1, according to the aspects of the present technique. In the illustrated embodiment, the generation of the EPS for each entity is illustrated by process 302 and detecting a quality defect and/or a process deviation is illustrated by process 304. At block 306, entity specification to be configured is provided to the system 100 and data ingestion for the entity is done (block 308). In some example embodiments, such data may be accessed from the repository 118 and may include entity data and process parameter data for a plurality of entities. In particular, the entity data includes product specifications, a defect type, defect specifications and location information. Moreover, the process parameter data may include data for deviating entities such as process readings, setup points and defect labels for the respective entities.

In this embodiment, the entities conforming to the product specifications, may be filtered from the complete set of entities available in the archival database. Further, the process parameter data that may include actual process readings, setup points and defect labels, is ingested for the selected products. As used herein, the term “process readings” refers to time stamped sensor measurements (such as L2 level time-series data) for each specified process. Such data is multi-variate time series data having measurements recorded from multiple processes across the enterprise. The process data collection may be done for certain locations such as until the mill location (sub-process) in the specified entity. For example, if mill location is Hot-Strip Mill (HSM) then process data is only collected from the beginning of the process till HSM sub-process. Moreover, the selected products along with their process data are divided into two categories either normal or defective, using the defect label specified in the entity specification and assigned to separate processing routes as illustrated in the figure.

At block 310, the data is analysed and for normal product data, the system 100 learns/identifies normal product process interactions (NPPI). Further, for defective/deviating product data, the system 100 analyses the process interactions of deviating entities against NPPI (block 312). In one example, the system 100 is configured to analyze the normal product process interactions using reconstruction-based anomaly detection techniques. Here, a lower-dimensional latent space is identified from the raw multi-variate process data of normal products to reconstruct the original multi-variate process data from this latent space. Further, the latent space is determined in an iterative manner till desired reconstruction accuracy is obtained on the normal set of products. As a result, a raw multi-variate process data of a normal product is projected to this latent space and reconstructed from the latent space. The differences in the original raw and reconstructed process data is ideally zero on the successful learning of this latent space. The latent space variables are recorded and referred as NPPI.

Moreover, the system 100 is configured to generate data such as difference maps using reconstructed and original multi-variate time series data for each entity. Such difference maps are representative of the EPS of the respective entity.

In this example, the entity characterization module 120 analyses the product quality defect data for the plurality of entities to identify one or more deviating entities. At block 314, EPS is registered for the respective entities. In operation, the entity specific process signature (EPS) generator 122 analyzes the product quality defect data and the process parameter data for the identified deviating entities to determine a plurality of relationships and/or interactions between quality defects and the process parameters and generates a unique EPS for each entity. Each of the generated EPS may be communicated to an expert/user of the system 100 for review and sign off (block 316). In addition, the generated EPS for each deviating entity may be registered with a master dictionary/EPS repository 126 (block 318). The EPS generation for the deviating entities may be performed from time to time by the system 100.

Further, as illustrated in process 304, real-time data ingestion is performed for the configured entities (block 320). Such data may be received from the monitoring system 116 of the system 100. Moreover, real-time process signatures of each of these entities are compared with EPS corresponding to the EPS entity by the EPS fuzzy matcher 124 and instances of EPS matches (322) are transmitted for review with diagnosis to a user/reviewer (blocks 322 and 324). Here, the EPS matches are indicative of a quality defect and/or a process deviation.

The EPS fuzzy matcher uses a fuzzy matching approach with a significance threshold to establish the match since. The instances of EPS matches between obtained difference map of the current process data and respective EPS signature, are recorded with the information on the time of occurrence and other required meta details for an expert review in the next sub-system.

In one example, the EPS fuzzy matcher 124 is configured to generate output diagnostic data for the detected EPS matches, wherein the output diagnostic data comprises uni-variate plots, bi-variate plots, visual comparison charts, or combinations thereof. In certain embodiments, the system 100 is further configured to recommend one or more corrective actions in response to the detected EPS matches. These corrective actions may be reviewed by the user/reviewer. The output data aids the human expert in reviewing the match instances with additional diagnostic details either around the out-of-control process parameters or unusual combination of multiple process parameters. It is important to note that match instances and diagnostic details are only relevant in the context of the respective entity and not applicable in general context of unusual processes or process interactions

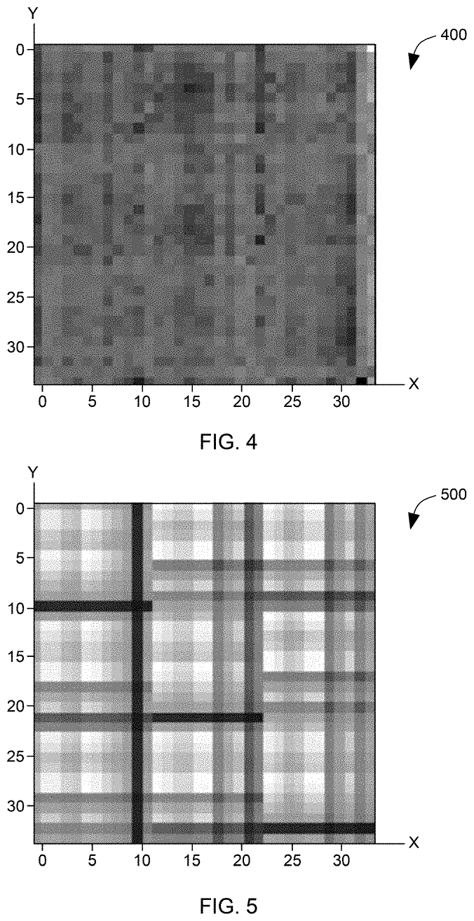

FIG. 4 illustrates example difference map 400 generated by the system 100 of FIG. 1 for a normal coil, according to the aspects of the present technique. In the illustrated example, the difference map 400 is generated for reconstructed and original multi-variate process data for a normal coil. Here, bins at X and Y axes represent raw time-series signal of process parameters and the color code represents the magnitude of difference value. The lighter shades represent higher differences while the darker shades represent relatively lower differences. It should be noted that the difference magnitude represented by dark shades indicates that latent space is successfully able to learn the process parameter interactions accurately for normal set of products (in this case coils). The shades may be color coded.

FIG. 5 illustrates a difference map 500 of a defective coil generated by the system 100 of FIG. 1., according to the aspects of the present technique. Here, the multi-variate process data of each defective coil is passed through the latent space and reconstructed. Further, the difference between the reconstructed and original process data is recorded for each defective coil to generate the difference map 500 for a defective coil.

In the illustrated embodiment, the difference map 500 obtained between reconstructed and original multi-variate process data for a defective coil. Here, bins at X and Y axis represent raw time-series signal of process parameters and the color code represents the magnitude of difference value. As illustrated, in process #10, there is no contribution in the target defect defined in the entity specification. Similarly, in other processes, such as in #5, #28, #17 high difference magnitude cells may be indicative of significant contribution in the reported defect.

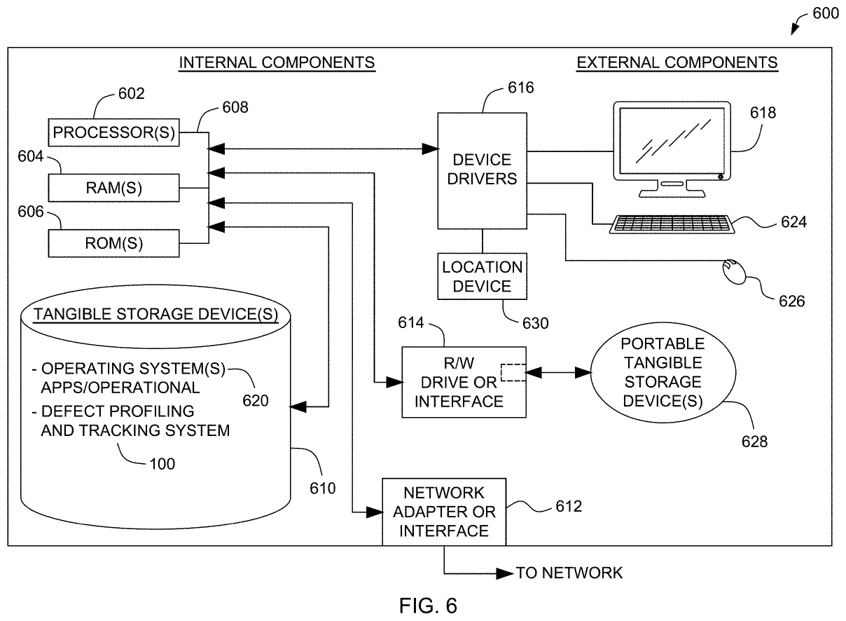

The modules of the defect profiling and tracking system 100 described herein are implemented in computing devices. One example of a computing device 600 is described below in FIG. 6. The computing device includes one or more processor 602, one or more computer-readable RAMs 604 and one or more computer-readable ROMs 606 on one or more buses 608. Further, computing device 600 includes a tangible storage device 610 that may be used to execute operating systems 620 and the defect profiling and tracking system 100. The various modules of the defect profiling and tracking system 100 include, a processor 104, a memory 106 and an output 108. Both, the operating system 620 and the system 100 are executed by processor 602 via one or more respective RAMs 604 (which typically includes cache memory). The execution of the operating system 620 and/or the system 100 by the processor 602, configures the processor 602 as a special purpose processor configured to carry out the functionalities of the operation system 620 and/or the defect profiling and tracking system 100, as described above.

Examples of storage devices 610 include semiconductor storage devices such as ROM, EPROM, flash memory or any other computer-readable tangible storage device that may store a computer program and digital information.

Computing device also includes a R/W drive or interface 614 to read from and write to one or more portable computer-readable tangible storage devices 628 such as a CD-ROM, DVD, memory stick or semiconductor storage device. Further, network adapters or interfaces 612 such as a TCP/IP adapter cards, wireless Wi-Fi interface cards, or 3G or 4G wireless interface cards or other wired or wireless communication links are also included in computing device.

In one example embodiment, the system 100 which includes a processor 104 with the entity characterization module 120, the EPS generator 122 and the EPS fuzzy matcher 124, and memory 106, may be stored in tangible storage device 610 and may be downloaded from an external computer via a network (for example, the Internet, a local area network or other, wide area network) and network adapter or interface 612.

Computing device further includes device drivers 616 to interface with input and output devices. The input and output devices may include a computer display monitor 618, a keyboard 624, a keypad, a touch screen, a computer mouse 626, and/or some other suitable input device.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

1. A defect profiling and tracking system for a process-manufacturing enterprise, comprising:
a memory having computer-readable instructions stored therein;
a processor configured to execute the computer-readable instructions to:
access entity data for a plurality of entities of the process-manufacturing enterprise, wherein the entity data comprises at least one of product specifications, a defect type, defect specifications and location information;
access process parameter data for one or more deviating entities, wherein the process parameter data comprises at least one of process readings, setup points and defect labels for the respective entities;
analyze the entity data and the process parameter data for each of the deviating entities to determine a plurality of relationships and/or interactions between quality defects and the process parameters and to generate a unique entity specific process signature (EPS) for each entity;
receive real-time process parameter data for one or more entities to generate a real-time process signature for each of the one or more entities; and
compare the real-time process signature of each entity with EPS corresponding to the entity to detect one or more EPS matches, wherein the EPS matches are indicative of a quality defect and/or a process deviation.

2. The defect profiling and tracking system of claim 1, wherein the processor is configured to execute the computer-readable instructions to:
analyze entity data to identify normal entities and the deviating entities;
utilize product process interactions for the normal and deviating entities to generate the EPS for the entities; and
store the EPS for each of the deviating entities.

3. The defect profiling and tracking system of claim 2, wherein the processor is configured to execute the computer-readable instructions to store the EPS for each of the deviating entities in an EPS repository.

4. The defect profiling and tracking system of claim 1, wherein the processor is configured to execute the computer-readable instructions to access the process parameter data received from a plurality of sensors configured to monitor the entities of the process-manufacturing enterprise, wherein the process parameter data comprises multi-variate time series data.

5. The defect profiling and tracking system of claim 4, wherein the processor is configured to execute the computer-readable instructions to analyze the normal product process interactions using reconstruction-based anomaly detection techniques.

6. The defect profiling and tracking system of claim 5, wherein the processor is configured to execute the computer-readable instructions to generate difference maps using reconstructed and original multi-variate time series data for each entity, wherein the difference map is representative of the EPS of the respective entity.

7. The defect profiling and tracking system of claim 1, wherein the process-manufacturing enterprise comprises manufacturing plant, a mill, an industrial set up, an assembly line, or combinations thereof.

8. The defect profiling and tracking system of claim 1, wherein the processor is configured to execute the computer-readable instructions to:
communicate the detected EPS matches to an expert; and
recommend one or more corrective actions in response to the detected EPS matches.

9. The defect profiling and tracking system of claim 1, wherein the processor is configured to execute the computer-readable instructions to detect the one or more EPS matches using a fuzzy matching technique based on a pre-determined threshold.

10. The defect profiling and tracking system of claim 2, wherein the processor is configured to execute the computer-readable instructions to generate output diagnostic data for the detected EPS matches, wherein the output diagnostic data comprises uni-variate plots, bi-variate plots, visual comparison charts, or combinations thereof.

11. The defect profiling and tracking system of claim 1, wherein the system is configured to be integrated with an existing process control program (PCP), process monitoring and quality assurance (PMQA) program, quality control program, or combinations thereof of the process-manufacturing enterprise.

12. A defect profiling and tracking system for a process-manufacturing enterprise, comprising:
a memory having computer-readable instructions stored therein;
a processor configured to execute the computer-readable instructions to access product quality defect data and process parameter data for a plurality of entities of the process-manufacturing enterprise and to encode relationships between the product quality defect data and process parameter data for one or more entities, wherein the processor comprises;
an entity characterization module configured to analyze product quality defect data for the plurality of entities to identify one or more deviating entities;
an entity specific process signature (EPS) generator configured to analyze the product quality defect data and the process parameter data for the identified deviating entities to determine a plurality of relationships and/or interactions between quality defects and the process parameters and to generate a unique entity specific process signature (EPS) for each entity; and
an EPS fuzzy matcher module configured to compare a plurality of real-time process signatures of each entity with EPS corresponding to the entity to detect one or more EPS matches, wherein the EPS matches are indicative of a quality defect and/or a process deviation.

13. The defect profiling and tracking system of claim 12, wherein the product quality defect data comprises at least one of product specifications, a defect type, defect specifications and location information.

14. The defect profiling and tracking system of claim 12, wherein the process parameter data comprises at least one of process readings, setup points and defect labels for the respective entities.

15. The defect profiling and tracking system of claim 12, wherein the system is configured to profile and control product defects in manufacturing process of steel strip.

16. The defect profiling and tracking system of claim 12, further comprising an EPS repository communicatively coupled to the EPS generator and to the EPS fuzzy matcher module, wherein the EPS repository is configured to store the EPS for each of the deviating entities and wherein the EPS repository is updated with the EPS matches on a periodic basis.

17. A defect profiling and tracking method for a process-manufacturing enterprise, the method comprising:
accessing entity data for a plurality of entities of the process-manufacturing enterprise, wherein the entity data comprises at least one of product specifications, a defect type, defect specifications and location information;
accessing process parameter data for one or more deviating entities, wherein the process parameter data comprises at least one of process readings, setup points and defect labels for the respective entities;
analyzing the entity data and the process parameter data for each of the deviating entities to determine a plurality of relationships and/or interactions between quality defects and the process parameters and to generate a unique entity specific process signature (EPS) for each entity;
receiving real-time process parameter data for one or more entities to generate a real-time process signature for each of the one or more entities; and
comparing the real-time process signature of each entity with EPS corresponding to the entity to detect one or more EPS matches, wherein the EPS matches are indicative of a quality defect and/or a process deviation.

18. The method of claim 17, comprising monitoring product defects for a steel strip production enterprise.

19. The method of claim 17, wherein generating the EPS for the deviating entities comprises identifying encoded representations of abnormal process interactions for the deviating entities.

20. The method of claim 17, further comprising alerting an operator with the detected EPS matches and facilitating adjustment of one or more processes of the enterprise.
